(19) United States
(12) Patent Application Publication
(10) Pub. No.: US 2016/0338806 A1
(43) Pub. Date: Nov. 24, 2016

(54) MULTI-COLORED MILL BLANKS

(71) Applicant: Custom Automated Prosthetics, LLC, Stoneham, MA (US)

(72) Inventors: Robert Nader Nazzal, Waltham, MA (US); Robert Neil Cohen, Gloucester, MA (US)

(21) Appl. No.: 15/160,691

(22) Filed: May 20, 2016

Related U.S. Application Data
(60) Provisional application No. 62/164,272, filed on May 20, 2015.

(51) Int. Cl. A61C 13/00; A61C 13/34; A61C 13/08

(52) U.S. Cl. CPC A61C 13/0022; A61C 13/082; A61C 13/0006; A61C 13/0004; A61C 13/34

(57) ABSTRACT

Two or more shades of material for creating dental restorations may be used concurrently in a single milling machine by cutting different shaded material blanks into two or more pieces and fitting these pieces together within the working volume of a milling machine. The different shaded pieces may be conjoined using a fixture or the like to retain the pieces in the form of a multi-shaded material blank for use by the milling system. Systems may implement computer-aided manufacturing (CAM) programming that is specifically tailored for concurrently or sequentially milling dental restorations having different shades from such a multi-shaded material blank or from two or more pieces of different shaded material blanks, e.g., by automatically or manually tracking the location of different shades of material and mapping the volume of dental restorations into suitable locations within the multi-shaded material blank.

### RELATED APPLICATIONS

This application claims the benefit of U.S. Prov. App. No. 62/164,272 filed on May 20, 2015, the entire content of which is hereby incorporated by reference.

This application is also related to U.S. patent application Ser. No. 14/705,114 filed on May 6, 2015, which claims priority to U.S. Prov. App. No. 61/989,265 filed on May 6, 2014 and U.S. Prov. App. No. 61/989,309 filed on May 6, 2014, where the entire contents of each of the foregoing is hereby incorporated by reference.

### TECHNICAL FIELD

The present disclosure generally relates to multi-colored material mill blanks, e.g., for milling more than one color or shade of dental restoration without having to continually change the mill blanks in a milling machine.

### BACKGROUND

Dental restorations such as bridges, crowns, and the like can be used to restore dental function and aesthetics for a dental patient. This may include a restoration fashioned for a prepared tooth stump, or when a tooth is entirely missing, for an implant. In one technique, the restoration may be milled from a ceramic disk using computer-aided design (CAD) and computer-aided manufacturing (CAM) techniques to design and fabricate the desired restoration. In order to match the color of a restoration to the surrounding dentition for a particular patient, the restoration may be dipped in a liquid solution (e.g., prior to sintering or other processing of the restoration), or this coloring step may be omitted by using a pre-shaded disk of starting material that more closely matches the desired final color.

While the use of pre-shaded disks can advantageously reduce the need for additional coloring-matching steps, it also imposes processing challenges because a milling technician must still batch milling jobs according to shade and swap disks every time a dental restoration requires a different shade. Milling machines have been equipped with disk changers to address these issues, but such machines are expensive and prone to mechanical failure, rendering them unsuitable for smaller dental laboratories. There remains a need for improved multi-colored milling techniques.

### SUMMARY

Two or more shades of material for creating dental restorations may be used concurrently in a single milling machine by cutting different shaded material blanks into two or more pieces and fitting these pieces together within the working volume of a milling machine. The different shaded pieces may be conjoined using a fixture or the like to retain the pieces in the form of a multi-shaded material blank for use by the milling system. Systems may implement computer-aided manufacturing (CAM) programming that is specifically tailored for concurrently or sequentially milling dental restorations having different shades from such a multi-shaded material blank or from two or more pieces of different shaded material blanks, e.g., by automatically or manually tracking the location of different shades of material and mapping the volume of dental restorations into suitable locations within the multi-shaded material blank.

### BRIEF DESCRIPTION OF THE DRAWINGS

The foregoing and other objects, features, and advantages of the devices, systems, kits, and methods described herein will be apparent from the following description of particular embodiments thereof, as illustrated in the accompanying drawings. The drawings are not necessarily to scale, emphasis instead being placed upon illustrating the principles of the devices, systems, kits, and methods described herein.

FIG. 1 is a top perspective view of a material blank.

FIG. 2 shows a material blank having multiple materials.

FIG. 3 is an exploded view of a material blank having multiple materials.

FIG. 4 shows a material blank having multiple materials.

FIG. 5 is an exploded view of a material blank having multiple materials.

FIG. 6 is a flow chart of a method for milling dental restorations from a material blank having multiple materials.

FIG. 7 is a flow chart of a method for milling dental restorations from a material blank having multiple materials.

FIG. 8 is a flow chart of a method for milling dental restorations from a material blank having multiple materials.

FIG. 9 illustrates a system for milling dental restorations from a material blank having multiple materials.

FIG. 10 is a flow chart of a method for milling dental restorations from multiple materials.

### DETAILED DESCRIPTION

The embodiments will now be described more fully hereinafter with reference to the accompanying figures, in which preferred embodiments are shown.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

Described herein are devices, systems, and methods for milling more than one shade of dental restoration without having to continually change material blanks, and more specifically devices, systems, and methods for concurrently milling material blanks having different shades. The devices, systems, and methods may utilize features disclosed in U.S. Provisional Application No. 61/989,309 entitled “Automatic Placement of a Design Into a Multi-Layered Disk,” filed on May 6, 2014 (Attorney Docket No. CAPR-0002-P60), the entire content of which is hereby incorporated by reference herein.

The term “dental restoration,” as used herein, is intended to refer broadly to subject matter related to dentistry. Dental restorations may be generally understood to include components that restore the structure or function of existing dentition, such as crowns, bridges, veneers, inlays, onlays, amalgams, composites, and various substructures such as copings and the like, as well as temporary restorations for use while a permanent restoration is being fabricated. Dental restorations may also include a prosthesis that replaces dentition with removable or permanent structures, such as dentures, partial dentures, implants, retained dentures, and the like. Dental restorations may also include appliances used to correct, align, or otherwise temporarily or permanently adjust dentition, such as removable orthodontic appliances, surgical stents, bruxism appliances, snore guards, indirect bracket placement appliances, and the like. Dental restorations may also include hardware affixed to dentition for an extended period, such as implant fixtures, implant abutments, orthodontic brackets, and other orthodontic components. Dental restorations may also include interim components of dental manufacture such as dental models (full and/or partial), wax-ups, investment molds, and the like, as well as trays, bases, dies, and other components employed in the fabrication of restorations, prostheses, and the like. Dental restorations may also be categorized as natural dental objects such as the teeth, bone, and other intraoral structures or as artificial dental objects such as restorations, prostheses, appliances, hardware, and interim components of dental manufacture. Although this document primarily references dental restorations, a skilled artisan will understand that the devices, systems, and methods described herein may be adapted for other items. For the purpose of this disclosure both implant supported and tooth supported dental restorations apply.

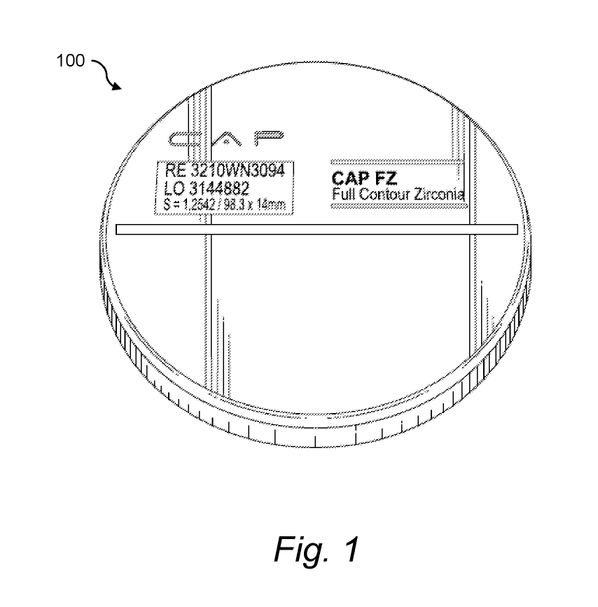

FIG. 1 is a top perspective view of a material blank. The material blank 100 shown in FIG. 1 may be the same or similar to those available in the prior art, which can be adapted for use by the devices, systems, and methods described herein. Any reference to a “material blank” herein may include the material blank 100 (or portions thereof) described with reference to FIG. 1, or material blanks known in the art or that become known, unless a different meaning is explicitly stated or otherwise clear from the context.

The material blank 100 may include a three-dimensional dental material intended for milling dental prosthetic devices, and may be shaped and sized for fabricating one or more dental restorations therefrom.

The material blank 100 may be made from a material suitable for creating dental restorations therefrom, including without limitation, one or more of: zirconia, polymethyl methacrylate (PMMA), wax, plastic, ceramic (e.g., resin nanoceramics), obsidian, metal, and so forth. The material blank 100 may also or instead include any materials that become known in the art.

As shown in FIG. 1, the material blank 100 may be in the shape of a disk. A person skilled in the art will recognize, however, that the material blanks as discussed herein may include other shapes. For example, the material blanks may include without limitation blocks, cubes, spheres, cones, cylinders, and so forth. Additionally, any reference herein to a “disk” shall also include all such shapes that are possible for material blanks unless a different meaning is explicitly stated or otherwise clear from the context.

The material blank 100 may include a range of different diameters and thicknesses. For example, the material blank 100 may include a disk with a diameter ranging from approximately 8-150 mm (e.g., about 98 mm), and a thicknesses of about 8-30 mm. The material blank 100 may be sized and shaped such that one or more dental restorations may be fabricated from the piece of material that makes up the material blank 100. For example, the material blank 100 may be sized to accommodate approximately 20-30 dental restorations that can be fabricated from the piece of material.

The material blank 100 may include pre-shaded material. The material blank 100 may be monochromatic and may include a shade to match the shade of existing teeth of a dental patient. The material blank 100 may instead be multi-chromatic having multiple layers of varying colors, translucencies, shades, and other optical properties, which may be selected from colors and other optical properties commonly occurring in natural dentition. For example, the material blank 100 may include at least six layers of different colors or translucencies. The material blank 100 may smoothly transition throughout its extent from one shade/color/opacity to another, or the material blank 100 may include layers with different properties, along with gradations from layer to layer, so that a transition between each shade, color, or translucency appears natural (i.e., the transitions are blended to avoid step discontinuities in optical properties with noticeable boundaries). The material blank 100 may be custom designed for a specific patient. Alternatively, the material blank 100 may be a universal design having common shades/colors/translucencies.

In another embodiment, the material blank 100 includes an unshaded material, where shading is added after fabricating a dental restoration, if at all. The post-milling shading may be added by dipping, hand shading, and the like.

The prior art generally lacks devices, systems, and methods utilizing material blanks 100 that combine different colors within a single, millable unit as contemplated herein. Disks of material blanks such as those described herein may be cut into sections (e.g., halves, quarters, eighths, etc.), and pieces of different shades may be reassembled into a millable blank (e.g., a disk) using a fixture or the like to retain the multiple pieces in a single milling machine. This may allow a technician to run a milling operation for two or more restorations having two or more different colors in a single, unattended process without requiring any swapping of the material blank or other hardware changes. Thus, the techniques described herein may eliminate a need to switch disks to mill two or more different shades for dental restorations.

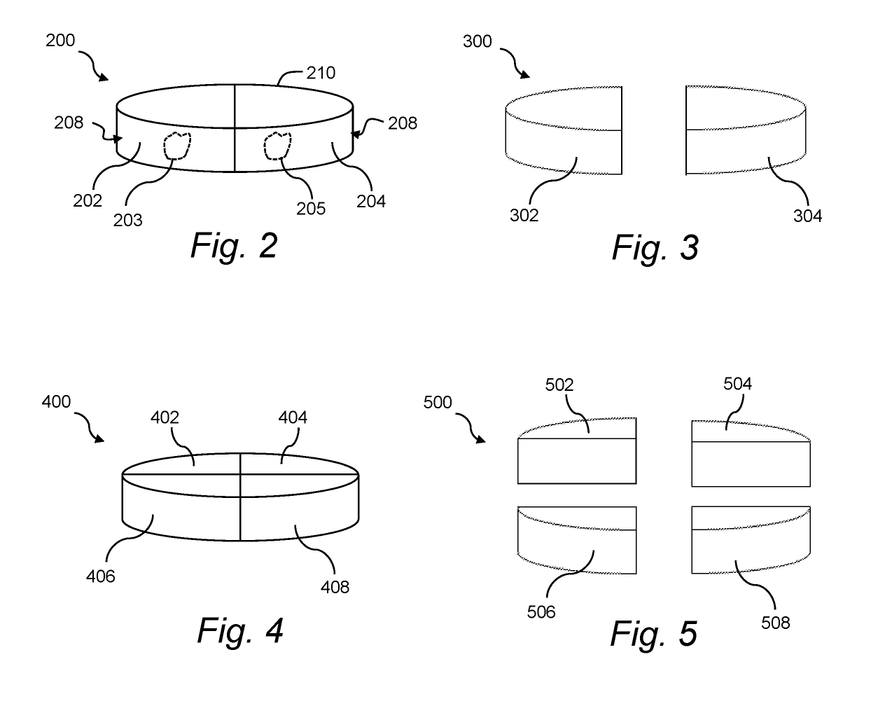

FIG. 2 shows a material blank having multiple materials. The material blank 200 may be made from one or more material blanks available in the prior art that are adapted for use as contemplated herein, e.g., by being cut into multiple pieces. Thus, the material blank 200 may include a first material portion 202 and a second material portion 204.

The first material portion 202 may be formed by cutting a first material blank (e.g., such as that shown above in FIG. 1) made from a first material having a first shade. Thus, the first material portion 202 may include the first shade, where the first material portion 202 is configured for milling a first dental restoration 203 having the first shade.

The first shade may be a shade in the traditional sense—a common dental shade such as A1 or A2 as known in the art of dentistry. Alternatively, the first shade may include one or more shades, colors, translucencies, textures, aesthetic properties, material properties (e.g., hardness), or other features, and “shade” as used in the context of the first shade, second shade, etc., shall refer to any and all such features/properties unless a different meaning is explicitly stated or otherwise clear from the context.

The second material portion 204 may be formed by cutting a second material blank made from a second material having a second shade. Thus, the second material portion 204 may include the second shade where it is configured for milling a second dental restoration 205 having the second shade.

The first material and the second material may be the same material (or plurality of materials) or they may be different materials. The first shade and the second shade may be the same shade (or variations of shades) or they may be different shades.

FIG. 3 is an exploded view of a material blank having multiple materials. As shown in FIG. 3, the material blank 300 may be formed by a first material portion 302 and a second material portion 304 that each make up substantially one-half of the material blank 300. This configuration may be advantageous because there can be diminishing returns on material blanks 300 cut into smaller portions—e.g., because of connectors and the like that may be required for certain dental restorations.

FIG. 4 shows a material blank having multiple materials. The material blank 400 may include a first material portion 402, a second material portion 404, a third material portion 406, and a fourth material portion 408. Thus, the material blank 400 may be formed by portions of other material blanks that are substantially cut into quarters.

FIG. 5 is an exploded view of a material blank having multiple materials. As shown in FIG. 5, the material blank 500 may be formed by a first material portion 502, a second material portion 504, a third material portion 506, and a fourth material portion 508, where each portion makes up about one-quarter of the material blank 500.

One skilled in the art will recognize that the material blanks discussed above may include more or less portions, materials, shades, pieces, etc., that are combined to form the material blanks. By way of example and not of limitation, a material blank may be formed by about eight different portions, where each portion is cut from a different material blank each having a different shade. Additionally, although the portions that form the material blanks in the figures above are generally shown to be the same or similar size, the portions may be different sizes and shapes. Further, although the portions appear to have substantially straight edges for forming together (i.e., it appears that the portions were cut in straight lines), the portions may instead be cut in different configurations. For example, the cuts may be more complex such that the portions fit together like puzzle pieces to form the material blank. The cuts may also or instead be curved or may include patterns.

The material blanks formed of different portions having different shades may be coupled together through any suitable mechanical connection or attachment including without limitation screws, nails, bolts, clamps, clips, friction or interference fits, hooks, latches, pins, sliders, and so forth. The different portions forming material blanks may also or instead be linked or retained together via an adhesive, a chemical bond, or other suitable means.

Further, the different portions forming material blanks may also or instead be linked or retained together through fixturing included on a milling machine or the like that positions and stabilizes the different portions. In one aspect, a fixture may be provided that securely fastens each individual piece independently, e.g., by securely and independently retaining each portion. For example, in an aspect where each portion forming a material blank includes a substantially wedge shape to form a material blank shaped as a disk, one or more fixtures may retain each wedge on its perimeter and/or on each planar side. Where individual shapes are secured within the milling machine, or to a template or the like that is inserted into the milling machine, control software for the milling machine may be configured to avoid machining the template or other support structure. Alternatively, the template may be formed of a sacrificial material that can be machined along with the mill blank materials. In another aspect, a number of individual vice or gripping surfaces may be provided for each portion of a material blank. Similar techniques may be adapted for many different shapes of raw material such as square or rectangular blanks as well as disks as discussed above.

While the description herein correctly notes that many different shapes can be used as mill blanks, the disks used for typical dental milling processes can advantageously be cut into pie wedge shapes of various angles, and assembled into a single blank using a circumferential tensioning device. Thus, portions of a material blank formed by halves, quarters, or any other combination of arcs/angles that form a substantially circular whole, may be secured using a fixture that concurrently and tangentially retains each portion by compression and friction fit against other portions. For example, a circular compression fitting may be used to circumferentially tension the pieces into a mechanically rigid, single part suitable for milling. For regular geometries such as quarters and halves, a corresponding number of radial tensioners may also or instead be used, e.g., to apply force radially toward a center of the circular disk at a number of locations 208 along a perimeter 210 of the disk, to retain the wedges in a single, machinable whole.

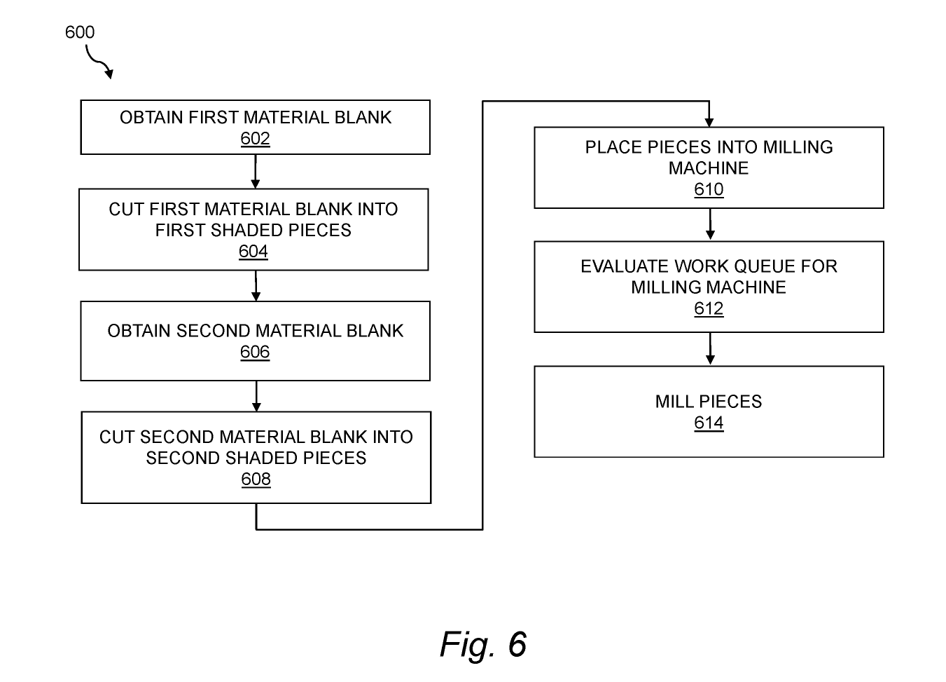

FIG. 6 is a flow chart of a method for milling dental restorations from a material blank having multiple materials.

As shown in step 602, the method 600 may include obtaining a first material blank for milling a first dental restoration having a first shade. The first material blank may be any of the material blanks as discussed herein, including without limitation, a disk having a first shade. The first shade may include one or more shades, i.e., the first material blank may have multiple shades.

As shown in step 604, the method 600 may include cutting the first material blank into a plurality of first shaded pieces. The first material blank may be cut into substantially equally-sized or shaped pieces, e.g., halves, quarters, eighths, sixteenths, and so on, or the first material blank may be cut into unequal pieces. The first material blank may be cut along straight lines, curved lines, patterns, and so on, e.g., such that the resulting first shaded pieces are configured to conjoin with pieces cut or formed from a second material blank. In one aspect, the first material blank is a disk and the first shaded pieces are cut to resemble slices of a pie, e.g., cut longitudinally. However, it is also or instead possible to cut the disks such that the resulting first shaded pieces maintain a disk-like shape, e.g., they are cut in a plane substantially parallel to the top and bottom surfaces. In another aspect, the first material blank is cut such that the resulting first shaded pieces form an interference fit through their shape (or otherwise cooperate or engage) with pieces cut or formed from a second material blank, e.g., similar to a jigsaw puzzle, dovetail joint or the like. The shape and size of the first shaded pieces may be dependent upon different factors, including without limitation, a particular milling machine, the shape, size, and type of the first dental restoration, and so forth.

The first material blank may be cut using any of a variety of suitable techniques including without limitation, a tool having a sharp edge (e.g., a saw or a knife), a rotary or reciprocating cutting tool, a computer numerical control (CNC) machine, a plasma cutter, a laser, an electric discharge machine (EDM), a water jet cutter, a hot wire cutter, and so forth.

The first shaded pieces may all have the same shade or they may have different shades.

As shown in step 606, the method 600 may include obtaining a second material blank for milling a second dental restoration having a second shade. The second material blank may be the same or similar to the first material blank as described above except that the second material blank includes one or more of a second shade or a second material. The second shade may include one or more shades, i.e., the second material blank may have multiple shades. In an aspect, the first shade and the second shade are different shades for dental restorations.

As shown in step 608, the method 600 may include cutting the second material blank into a plurality of second shaded pieces. The second shaded pieces may be the same or similar to the first shaded pieces as described above except that the second shaded pieces include the second shade. In another aspect the first shaded pieces, second shaded pieces, etc., are provided as pre-cut or pre-formed pieces.

The first shaded pieces and the second shaded pieces may be shaped and sized such that they combine to form a common shape for material blanks in dental restoration milling, e.g., a disk. For example, the first shaded piece may be one-half of a disk-shaped first material blank, and the second shaded piece may be one-half of a disk-shaped second material blank, where the combination of the first shaded piece and the second shaded piece results in a disk-shaped material blank having the first shade on about one half and the second shade on another half, thereby forming a multi-shaded material blank. In one aspect, the first and second material blanks may be cut into complementary shapes that can be assembled together, from among the pieces of different blanks, into a shape corresponding to the original shape of either of the blanks. While this is not strictly necessary, and fixturing or the like may be adapted to accommodate a range of geometric variations, this general approach advantageously facilitates the use of existing and readily available milling machines on one hand and mill blanks on the other. One skilled in the art will recognize that more pieces may be used and/or different shapes may be formed using the first shaded pieces and the second shaded pieces, as well as any number of pieces from blanks with other shades, mechanical properties, and so forth.

As shown in step 610, the method 600 may include placing at least one of the plurality of first shaded pieces and at least one of the plurality of second shaded pieces into a milling machine. The first shaded pieces and the second shaded pieces may be placed into the milling machine together, e.g., in the shape that they combine to form (e.g., a disk), or they may be placed in the milling machine separately.

The milling machine may be a CNC machine. Although this document references a milling machine, a skilled artisan will recognize that other machines, including other CNC machines, may also or instead be used. The other machines may include without limitation a lathe, plasma cutter, EDM, water jet cutter, drill, router, hot wire cutter, grinder, or any other machine or combination of machines suitable for forming a dental article from a material blank as contemplated herein.

The milling machine may be a standard milling machine that is configured for receiving one material blank, e.g., a single disk. The milling machine may instead be adapted for receiving a plurality of shaded pieces. For example, the milling machine may include fixturing configured for holding and aligning a plurality of shaded pieces in a particular alignment—e.g., half-disks, quarter-disks, eighth-disks, and so forth. This fixturing may allow for the milling of multiple shades in the same milling machine without having to change material blanks and/or during a single milling operation. The milling machine may also or instead include a mechanism for changing the material blanks, although one is not necessary for the embodiments described herein.

As shown in step 612, the method 600 may include evaluating a work queue to determine an appropriate mix of sub-pieces for the milling machine. For example, if a short term queue is 25% one color and 75% a second color, the disk may be formed of a quarter-portion of the first color and a three-quarter portion of the second color (which may in turn be formed of three quarters, a single piece, one half and one quarter, or any other suitable arrangement). While there are practical limits to the number of subdivisions that can be made to disks, and the number of different-colored or shaded restorations that can be milled in a single disk, this general notion of dividing and allocating colors or shades according to the current queue can be adapted in a variety of manners to improve fabrication throughput by reducing requirements for manual activities and intervention by a trained technician or the like.

As shown in step 614, the method 600 may include milling the first shaded piece and the second shaded piece using the milling machine thereby milling the first dental restoration and the second dental restoration in a single milling operation without changing milling material. The milling machine may include one or more tool heads for milling the first dental restoration and the second dental restoration. For example, in one aspect, the milling machine mills a disk formed of a first shaded piece made of one-half of a disk-shaped first material blank and a second shaded piece made of one-half of a disk-shaped second material blank using a single tool head, where the tool head follows a path for milling the first dental restoration and the second dental restoration seamlessly as the tool head travels across the halves of the disk. For example, after the milling machine mills a portion of the first dental restoration on one half of the disk at a particular depth, the tool head may mill a portion of the second dental restoration on the other half of the disk at the same depth before starting to mill the design at a deeper depth. In other words, the milling of the first dental restoration and the second dental restoration may be done concurrently by a single tool head. This may be accomplished through the use of tool instructions and design files configured as appropriate for such purposes. In another aspect, multiple tool heads are used, where each is assigned to a specific dental restoration. In one implementation, the milled dental restorations may be connected via a connector or the like that retains the first and second dental restorations as a single, integral workpiece during the machining process. A connector may also or instead connect the dental restorations to other pieces of material, e.g., other portions of the material blank.

As stated above, the single milling operation that can be provided by using implementations described herein may include concurrently milling the first dental restoration and the second dental restoration. In another aspect, the single milling operation includes sequentially milling the first dental restoration and the second dental restoration.

The method 600 may be similarly performed using a third material blank, a fourth material blank, and so on, such that many different shades are incorporated into a single mill blank. In general, the color mix of the disk may be mapped into software either manually, e.g., by manually specifying which colors are where, or automatically, e.g., by detecting color with a color camera or other color sensing hardware, or by reading a bar code, radio frequency identification (RFID) tag or other computer-readable information associated with the material(s). Similarly, individual dental restorations may be automatically placed in suitable locations within the multi-colored disk according to a specification of color or shade for each restoration, e.g., in a dental treatment plan or the like. In this manner, a third dental restoration, a fourth dental restoration, and so on, may be milled of different-colored material in different locations within the disk.

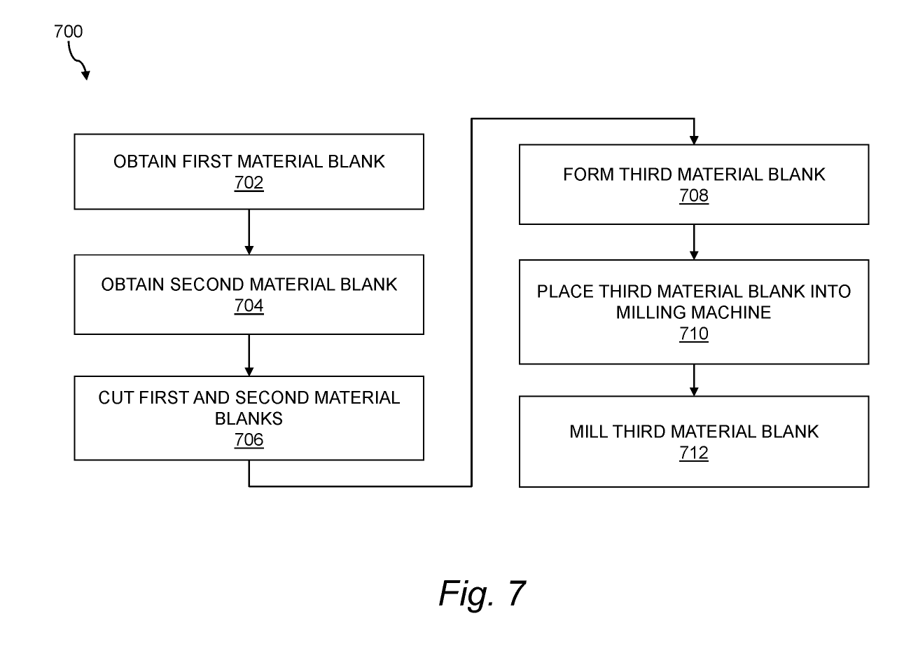

FIG. 7 is a flow chart of a method for milling dental restorations from a material blank having multiple materials.

As shown in step 702, the method 700 may include obtaining a first material blank having a first shade. The first material blank may include a first partial shape for milling a first dental restoration having the first shade. In an aspect, the first partial shape may include a partial disk.

As shown in step 704, the method 700 may include obtaining a second material blank having a second shade. The second material blank may include a second partial shape for milling a second dental restoration having the second shade. The first shade and the second shade may be different shades for dental restorations. In an aspect, the second partial shape may include a partial disk. The first partial shape and the second partial shape may combine to form a third material blank having a predetermined shape.

As shown in step 706, the method 700 may include cutting the first material blank into the first partial shape and cutting the second material blank into the second partial shape. The first partial shape and the second partial shape may be specifically sized and shape for combining into a composite material blank, e.g., the third material blank that has both the first shade and the second shade.

As shown in step 708, the method 700 may include forming the third material blank from at least the first partial shape and the second partial shape. This may include affixing the first partial shape to the second partial shape to form the third material blank having the predetermined shape. The predetermined shape of the third material blank may include a disk or the like. As noted above, forming the third material blank may include apportioning the different colored materials according to the color(s) specified in a queue of dental restorations.

As shown in step 710, the method 700 may include placing the third material blank into a milling machine. The third material blank formed of multiple materials or pieces (e.g., the first material blank and the second material blank) may be rotated according to a desired location of the different materials (e.g., different-colored components). The third material blank may also or instead be automatically scanned or the like to determine the location of the different materials (e.g., the different-colored regions) within the milling space where dental restorations or the like will be fabricated.

As shown in step 712, the method 700 may include milling the third material blank using the milling machine thereby concurrently milling the first dental restoration and the second dental restoration in a single milling operation without changing milling material. This may also include a preparatory step of placing each digital model of a restoration in a suitable location within the third material blank (e.g., the combined multi-colored disk). The milling of the third material blank may include concurrently milling the first dental restoration and the second dental restoration. Alternatively, the milling of the third material blank may include sequentially milling the first dental restoration and the second dental restoration.

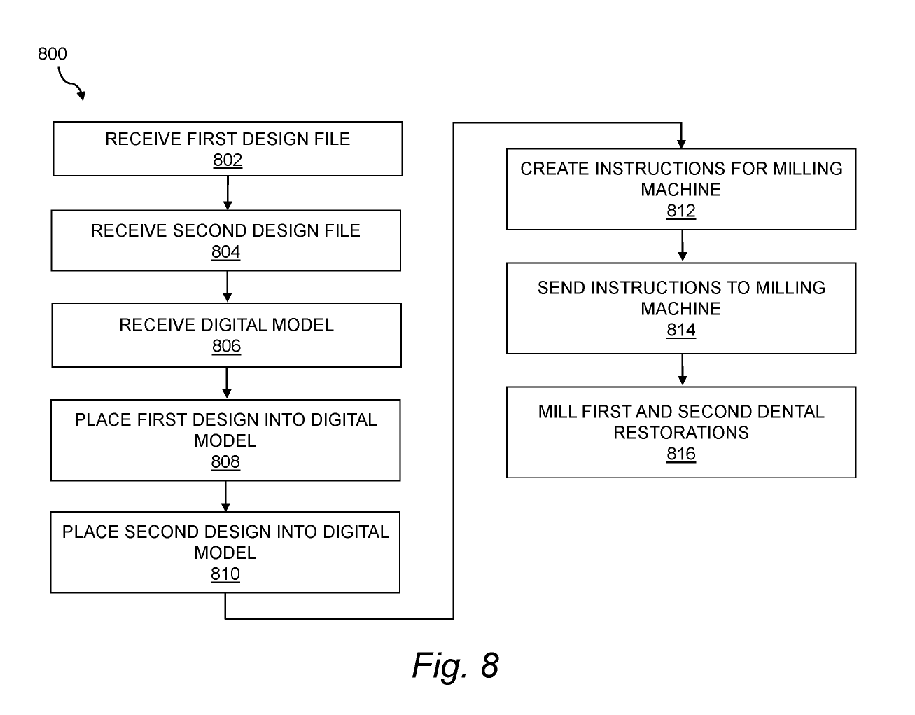

FIG. 8 is a flow chart of a method for milling dental restorations from a material blank having multiple materials. The method 800 may be associated with a computer program product including computer executable code embodied in a non-transitory computer readable medium that, when executing on one or more computers, performs the steps of the method 800.

As shown in step 802, the method 800 may include receiving a first design file including a first three-dimensional design of a first dental restoration having a first shade. The first three-dimensional design may include without limitation one or more of a three-dimensional model, a three-dimensional surface representation, a digital surface representation, a three-dimensional surface map, or any other three-dimensional representation or the like (e.g., point clouds and polygonal meshes) of a dental restoration as described herein. This may include data created using three-dimensional modeling software, data captured from a three-dimensional scan, or some combination of these.

The design of the first dental restoration may include a size and shape to match a specific patient's anatomy. The design of the dental restoration may also include color and translucency (or opacity) information which may, for example, include surface data or volumetric data, or some combination of these. The color data for the design may be based on default models, estimates of the patient's dentition color, or actual measurements of a dentition being replaced by the restoration using, e.g., a color camera or other chromatographic techniques. The color and translucency may change throughout the design of the dental restoration, with a change that may be gradual or abrupt, or some combination of these.

The first design file may be received through uploading or downloading the first design file to a computer program or application. The first design file may be received through a scanning process or the like. The first design file may be selected from a plurality of design files, e.g., from a database or library of design files. The first design file may also or instead include a plurality of designs.

As shown in step 804, the method 800 may include receiving a second design file including a second three-dimensional design of a second dental restoration having a second shade. The second design file, second three-dimensional design, and second dental restoration may include the same or similar properties to those described above for the first design file, first three-dimensional design, and first dental restoration, respectively.

As shown in step 806, the method 800 may include receiving a digital model of a material blank that is used to mill one or more dental restorations. The material blank may include at least a first partial blank including the first shade and a second partial blank including the second shade. Thus, the material blank may include a composite material blank made from two or more material blanks having different properties.

The digital model may be received through uploading or downloading the digital model to a computer program or application. The digital model may be received through a scanning process or the like, where the physical piece of material blank is scanned to create the digital model. The digital model may be selected from a plurality of digital models, e.g., from a database or library of digital models. The digital model may include a plurality of models.

As shown in step 808, the method 800 may include placing the first three-dimensional design into the digital model of the material blank such that it is disposed in the first partial blank. Placing the first three-dimensional design into the digital model of the material blank may include using one or more placement criteria such as color, color difference, opacity, opacity difference, or any other metric, cost function, error function, or combination of the foregoing that is amenable to quantitative evaluation and use in selecting a location for fabricating the design within the material blank. This may be particularly useful where, for example, each material blank section has a graded color. Thus for example, each piece may have a different range of shades, and the selection of a particular piece of material, as well as a location within the (color-graded) piece of material, may be made to achieve a desired color of the fabricated object.

More generally, any of a variety of techniques may be used to place the first three-dimensional design within the material blank. For example, the placement criteria may include color or translucency, where placement is determined by minimizing a difference between optical properties of the first three-dimensional design as placed in the material blank versus optical properties of the dentition being replaced or surrounding dentition (which may be represented in the digital model of the restoration or obtained from an independent source). In another aspect, a particular portion of the restoration, such as a top third of the volume, occlusal surfaces, top surfaces, or some other portion of the top surface or other areas of the restoration, e.g., a most visible surface area of the restoration when placed for use, may be matched to an area or layer within the material blank as closely as possible. The restoration may also or instead be rotated and translated as appropriate within the material blank so that this top portion is placed appropriately.

In another aspect, verification of the placed three-dimensional design may be facilitated by creating a visualization of the physical restoration that will result from a particular placement. This may be accompanied by a placement tool in a graphical user interface or the like that permits a user to adjust a position of the restoration within the material blank, while viewing the resulting changes in aesthetics that result from changes in position. More generally, a variety of techniques are contemplated herein including manual (e.g., computer assisted manual placement), semi-automated (e.g., automatic initial placement with manual refinements), and fully automated techniques for positioning a three-dimensional design within a material blank having multiple shades, colors, or other material properties (aesthetic or otherwise). This may include a pre-fabricated, single mill blank, e.g., formed of different regions with different discrete colors and/or regions of graded color, or a composite milling blank formed as generally contemplated herein, or some combination of these. Where the mill blank has a relatively complex color distribution, visualization software may be particularly useful in assisting a manual placement process.

As shown in step 810, the method 800 may include placing the second three-dimensional design into the digital model of the material blank such that it is disposed in the second partial blank. This may include any of the features or steps discussed above with reference to placing the first three-dimensional design.

As shown in step 812, the method 800 may include creating instructions for the milling machine to mill the first dental restoration and the second dental restoration from the material blank. The instructions may include a tool path of the milling machine, as well as any other information such as tool changes, rotary tool speeds, lubricants or fluids to be applied during machining, and so forth. In general, the instructions for a material removal machining path through/in the blank may be based on placement of the first three-dimensional design and the second three-dimensional design into the digital model of the material blank.

As shown in step 814, the method 800 may include sending instructions to a milling machine.

As shown in step 816, the method 800 may include milling the first dental restoration and the second dental restoration based on the instructions.

The computer program product described above, or the systems otherwise described herein, may include a computer-aided manufacturing (CAM) program. The CAM program may be particularly configured for milling dental restorations from one or more material blanks having multiple materials. For instance, the CAM program may include software that indicates where the boundaries on the material blank are located, e.g., where the material blank changes from one shade to another such as at a location where two different material blanks are conjoined. The CAM program may include, or work in conjunction with, a computer-aided design (CAD) system. While described as separate software environments, it will be appreciated that a CAD system may be integrated into a CAM system to provide a single user environment. Similarly, these platforms may be further separated, e.g., into a scanning system, dental modeling system, CAD system, CAM system, and so forth in a variety of ways to facilitate digital modeling and fabrication of a dental restoration as contemplated herein.

In an aspect, software may optimize placement of the three-dimensional designs into a multi-shaded material blank. A user interface may be provided where a technician or the like can place three-dimensional designs of dental restorations into a multi-shaded virtual material blank in order for the technician to see what the dental restoration will look like when milled. The technician may be able to adjust the position of the three-dimensional designs within the virtual material blank, for example, by moving the design up or down, or rotating the design.

In another aspect, an error minimization function is utilized to place three-dimensional designs of dental restorations into a multi-shaded material blanks. In this manner, a technique may include mathematical optimization for selecting the optimal position of the three-dimensional designs based on shade. The function may closely-match the placement of the three-dimensional designs into a virtual material blank by matching the shades of the three-dimensional designs within the virtual material blank to an optimal color scheme for a dental restoration. The optimal color scheme for the dental restoration may be based off of a photograph of a patient's tooth, a photograph of a dental restoration, an idealized tooth model, and so forth.

The CAM software may include an algorithm configured to automatically place three-dimensional designs of dental restorations into a multi-shaded material blanks. The CAM software may identify a color or colors of a portion of a dental restoration, and attempt to match the color of the three-dimensional design of the dental restoration based on matching this portion. Additionally or alternatively, the CAM software may identify a color of a portion of the multi-shaded material blank, and attempt to match the color of the three-dimensional design of the dental restoration based on matching this portion. The CAM software may include analysis of other portions as well. In one aspect, a visually significant portion of the dental restoration is prioritized over other portions of the dental restoration. For example, the color of the top one-third of the dental restoration may be prioritized over other areas of the dental restoration.

In another aspect, the CAM program may apply design rules to insure that the structural integrity of the multi-piece mill blank is not impaired during milling in any manner that might cause the blank to release from a fixture. To this end, the CAM program may impose structural constraints on a multi-piece mill blank. For example, design rules may specify a minimum internal structure for maintaining the mill blank within a fixture, which may vary according to the number, size, shape, and arrangement of individual mill blank pieces that are assembled into the multi-colored, multi-sectioned mill blank.

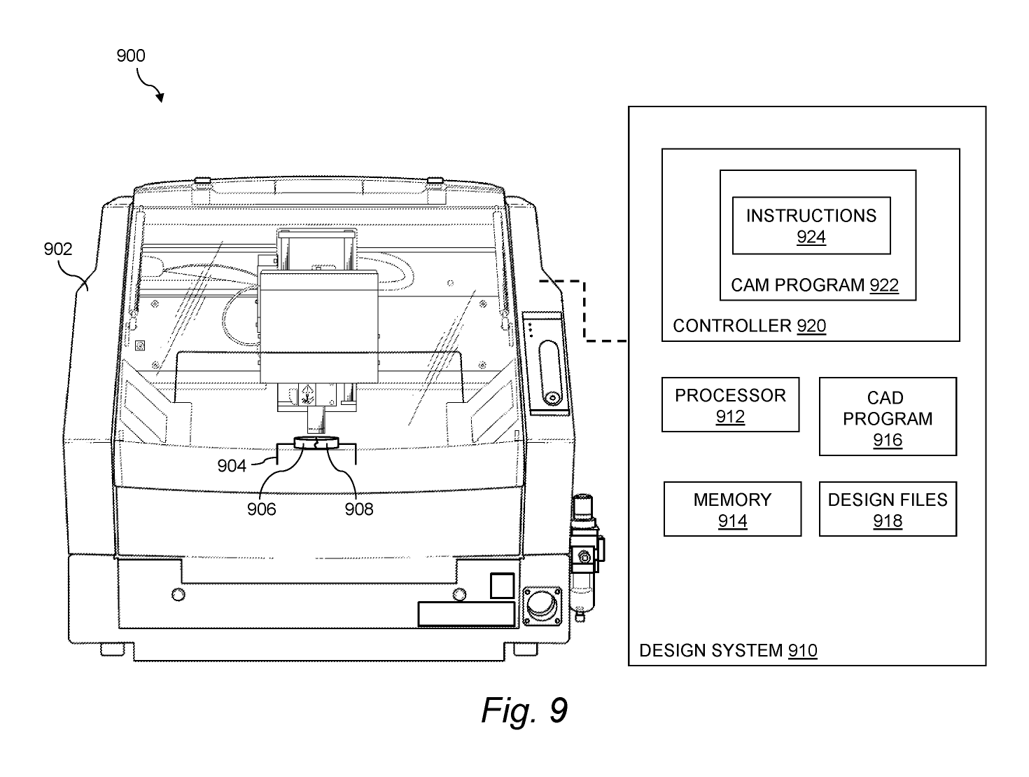

FIG. 9 illustrates a system for milling dental restorations from a material blank having multiple materials. The system 900 may include a milling machine 902 and a design system 910.

The milling machine 902 may include fixturing 904 configured to hold a first material blank 906 for milling a first dental restoration having a first shade and a second material blank 908 for milling a second dental restoration having a second shade. The milling machine 902 may also or instead include fixturing 904 to hold more than two shaded material blanks. The milling machine 902 may be any as described herein or otherwise known in the art.

The design system 910 may include one or more of a processor 912, a memory 914, a computer-aided design (CAD) program 916, design files 918, and a controller 920.

The controller 920 may include a CAM program 922 for providing instructions 924 to the milling machine 902 for milling the first dental restoration and the second dental restoration. In one aspect, the instructions 924 provide for concurrently milling the first dental restoration and the second dental restoration, or sequentially milling the first dental restoration and the second dental restoration without having to change a material blank. The CAM program 922 may include software that accounts for multiple shades within a material blank disposed in a milling machine 902 or fixturing 904 of the milling machine 902.

The milling instructions 924 may be sent by the controller 920, where the controller 920 sends a control signal based on the milling instructions 924. The controller 920 may send control signals to one or more components of the milling machine 902. The controller 920 may be configured to receive feedback from the milling machine 902, and to receive instructions 924 from the CAM program 922 or other software. The controller 920 may be electrically or otherwise coupled in a communicating relationship with one or more components of the overall system 900 (e.g., components including the CAM software and components of the milling machine 902). The controller 920 may include any combination of software and/or processing circuitry suitable for controlling the various components of the system 900 described herein including without limitation microprocessors, microcontrollers, application-specific integrated circuits, programmable gate arrays, and any other digital and/or analog components, as well as combinations of the foregoing, along with inputs and outputs for transceiving control signals, power signals, sensor signals, and so forth. In one aspect, this may include circuitry directly and physically associated with the components of the system, such as a processor 912. In another aspect, this may be a processor 912, which may be associated with a personal computer or other computing device coupled to the components of the system, e.g., through a wired or wireless connection. Similarly, various functions described herein may be allocated between a controller 920, processor 912, and a separate computer. All such computing devices and environments are intended to fall within the meaning of the term “controller” or “processor” as used herein, unless a different meaning is explicitly provided or otherwise clear from the context.

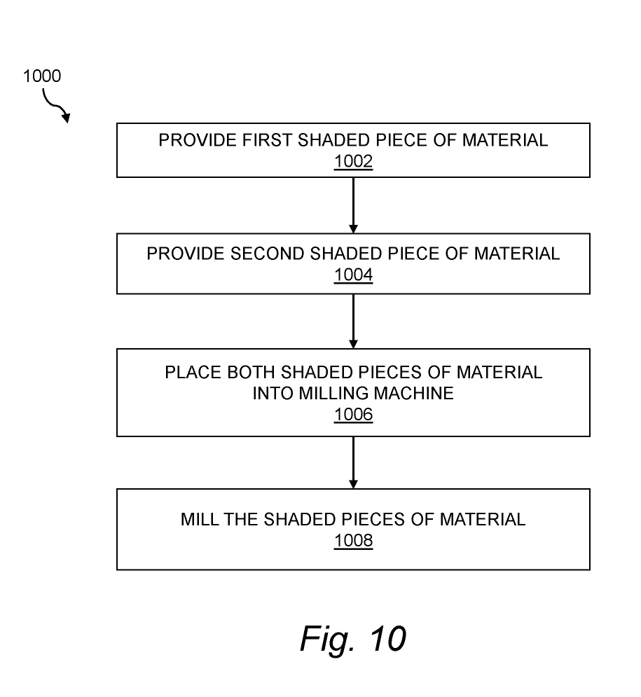

FIG. 10 is a flow chart of a method for milling dental restorations from multiple materials. The method demonstrates that shaded material for milling may be provided in shapes that cooperate with other shapes of shaded material and allow for the insertion of multiple shaded materials into a milling machine. Thus, pieces of shaded material may be fabricated for cooperation with other pieces of shaded material, or they can be otherwise fabricated for insertion into a milling machine with other pieces of shaded material.

As shown in step 1002, the method 1000 may include providing a first shaded piece of material for milling a first dental restoration having a first shade. The first shaded piece of material may be provided by cutting a first material blank having the first shade.

As shown in step 1004, the method 1000 may include providing a second shaded piece of material for milling a second dental restoration having a second shade. The second shaded piece of material may be provided by cutting a second material blank having the second shade.

As shown in step 1006, the method 1000 may include placing both the first shaded piece of material and the second shaded piece of material into a milling machine.

As shown in step 1008, the method 1000 may include milling the first shaded piece of material and the second shaded piece of material using the milling machine without changing milling material included in the milling machine. In one aspect, the milling of the first shaded piece of material and the second shaded piece of material using the milling machine occurs concurrently, thereby concurrently milling the first dental restoration and the second dental restoration. In another aspect, the milling the first shaded piece of material and the second shaded piece of material using the milling machine occurs non-concurrently, e.g., sequentially.

The devices, systems, methods, and techniques described herein may be beneficial for smaller milling facilities that do not have the resources for milling machines with material blank changing mechanisms, and do not have sufficient work volume to consistently schedule jobs that use all available space within a mill blank. Even in larger-scale facilities, the techniques described herein may usefully alleviate problems that arise in the context of machines that automatically change mill blanks. Using an embodiment described herein, a milling operation may be able to enhance its production of dental restorations and increase its efficiency. For example, efficiency can be increased when using a milling machine with a material blank made from two different shades of materials, e.g., the two most common shades—A1 & A2. These shades can be placed simultaneously into a milling machine, e.g., for overnight milling with little or no oversight, or without a need for material switching. To this end, to further increase efficiency, a mill can schedule a protocol to end the working day with the two or other number of most common shades in the milling machine.

The devices, systems, and techniques described herein may also be beneficial because it may not be necessary or desirable to have more than three, eight, or sixteen shades on hand to cover most teeth (e.g., a high percentage of dental restorations come in one of three shades). Thus, using the techniques described herein and operating with, e.g., three shades, a milling operation may be able to use a single milling machine to mill three shades in a single milling operation without changing material, rather than using multiple machines or changing material blanks when a different shade is to be milled.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method comprising:
obtaining a first material blank for milling a first dental restoration having a first shade;
cutting the first material blank into a plurality of first shaded pieces;
obtaining a second material blank for milling a second dental restoration having a second shade;
cutting the second material blank into a plurality of second shaded pieces;
placing at least one of the plurality of first shaded pieces and at least one of the plurality of second shaded pieces into a milling machine; and
milling the at least one of the plurality of first shaded pieces and the at least one of the plurality of second shaded pieces using the milling machine thereby milling the first dental restoration and the second dental restoration in a single milling operation without changing milling material.

2. The method of claim 1 wherein the first material blank and the second material blank are cut substantially in half.

3. The method of claim 1 wherein the first material blank and the second material blank are cut substantially in quarters.

4. The method of claim 1 wherein the first material blank and the second material blank are cut substantially in eighths.

5. The method of claim 1 wherein the at least one of the plurality of first shaded pieces and the at least one of the plurality of second shaded pieces combine to form a common shape for material blanks in dental restoration milling.

6. The method of claim 5 wherein the common shape is a disk.

7. The method of claim 1 wherein the milling machine is a computer numerical control (CNC) machine.

8. The method of claim 1 wherein the first shade and the second shade are different shades for dental restorations.

9. The method of claim 1 wherein at least one of the first shade and the second shade include multiple shades.

10. The method of claim 1 wherein the single milling operation includes concurrently milling the first dental restoration and the second dental restoration.

11. The method of claim 1 wherein the single milling operation includes sequentially milling the first dental restoration and the second dental restoration.

12. A method comprising:
obtaining a first material blank having a first shade, the first material blank including a first partial shape for milling a first dental restoration having the first shade;
obtaining a second material blank having a second shade, the second material blank including a second partial shape for milling a second dental restoration having the second shade, wherein the first partial shape and the second partial shape combine to form a third material blank having a predetermined shape;
placing the third material blank into a milling machine; and
milling the third material blank using the milling machine thereby milling the first dental restoration and the second dental restoration in a single milling operation without changing milling material.

13. The method of claim 12 wherein the predetermined shape is a disk.

14. The method of claim 12 wherein the milling of the third material blank includes concurrently milling the first dental restoration and the second dental restoration.

15. The method of claim 12 wherein the milling of the third material blank includes sequentially milling the first dental restoration and the second dental restoration.

16. The method of claim 12 further comprising cutting the first material blank into the first partial shape and cutting the second material blank into the second partial shape.

17. The method of claim 12 further comprising affixing the first partial shape to the second partial shape to form the third material blank having the predetermined shape.

18. The method of claim 12 wherein the first shade and the second shade are different shades for dental restorations.

19. A computer program product comprising computer executable code embodied in a non-transitory computer readable medium that, when executing on one or more computers, performs the steps of:
receiving a first design file including a first three-dimensional design of a first dental restoration having a first shade;
receiving a second design file including a second three-dimensional design of a second dental restoration having a second shade;
receiving a digital model of a material blank used to mill one or more dental restorations, the material blank including at least a first partial blank including the first shade and a second partial blank including the second shade;
placing the first three-dimensional design into the digital model of the material blank such that it is disposed in the first partial blank;
placing the second three-dimensional design into the digital model of the material blank such that it is disposed in the second partial blank;
sending instructions to a milling machine, the instructions including a tool path of the milling machine, and the instructions based on placement of the first three-dimensional design and the second three-dimensional design into the digital model of the material blank; and
milling the first dental restoration and the second dental restoration based on the instructions.

20. The computer program product of claim 19 further comprising code that performs the step of creating the instructions for the milling machine for milling the first dental restoration and the second dental restoration from the material blank.
